(19) United States
(12) Patent Application Publication
(10) Pub. No.: US 2025/0021586 A1
(43) Pub. Date: Jan. 16, 2025

(54) RELATIONSHIP DISCOVERY IN STRUCTURED DATA AND SHORTEST PATH TO DATA

(71) Applicant: Cisco Technology, Inc., San Jose, CA (US)

(72) Inventors: Derek William Engi, Pleasant Ridge, MI (US); Brett Dunstan, Newtown (AU); Peter Jozef Hugo De Vriendt, Denderleeuw (BE); Ravi Garg, Chicago, IL (US)

(21) Appl. No.: 18/350,143

(22) Filed: Jul. 11, 2023

(51) Int. Cl. G06F 16/28

(52) U.S. Cl. CPC G06F 16/288

(57) ABSTRACT

A method for learning potential correlation of data structures and fields across multiple disparate data sources. The method automatically identifies relationships that exist in multiple data sources to facilitate a data broker that can return the “shortest-path-to-data”. The method includes communicating with a data lake that integrates access to data stored in a plurality of different data sources. The method next includes correlating, via the data lake, data fields in data sets across the plurality of different data sources to identify relationships across the plurality of different data sources. A request to access data is obtained, and the method determines that data for the request is stored in two or more data sources of the plurality of different data sources, selects a particular data source of the two or more data sources and retrieves the data for the request from the particular data source.

### TECHNICAL FIELD

The present disclosure relates to communications related to data accesses.

### BACKGROUND

Data lakes may contain multiple sources of truth providing data in multiple different formats, where repeat structure usage and integrity is not consistent. This implies that there may be missing linkages between data or that duplicate data is being collected and sent to data lakes. For example, network data is collected that includes data fields (names) and data types associated with network devices in a network. Some of the data is based on naming conventions from many years ago. There is a challenge in identifying when a comparison is being made of the same data items, and what fields are available in disparate data sources that could be pulled together when a data query is being made for all available information for a particular element.

### BRIEF DESCRIPTION OF THE DRAWINGS

FIG. 1 is a block diagram of a system in which techniques are employed for data discovery and relationship mapping to expedite and enhance data retrieval, according to an example embodiment.

FIG. 2 is a flow diagram that depicts in more detail the pattern discovery and data relationship mapping operations, according to an example embodiment.

FIG. 3 illustrates an example pattern distribution for a given key in a test data set, according to an example embodiment.

FIG. 4 illustrates a graph that depicts the correlation confidence between data sources and fields, according to an example embodiment.

FIG. 5 is a flow diagram that depicts a process by which path selection is made for data retrieval based on data cataloging, according to an example embodiment.

FIG. 6 is a flowchart of an example method for accessing data via a data lake that integrates a plurality of different data sources, according to an example embodiment.

FIG. 7 above illustrates a hardware block diagram of a device that may perform functions associated with operations presented herein, in accordance with an example embodiment.

### DESCRIPTION OF EXAMPLE EMBODIMENTS

### Overview

Presented herein are techniques to perform a richer cataloging of data by identifying potential correlation points among the data that may or may not look similar in structure. This correlation provides the benefit of learning how data systems are interconnected and subsequently benefits downstream querying mechanisms by taking data storage considerations into play for more efficient data retrieval.

In one form, a computer-implemented method is provided. The method includes communicating with a data lake that integrates access to data stored in a plurality of different data sources. The method next includes correlating, via the data lake, data fields in data sets across the plurality of different data sources to identify relationships across the plurality of different data sources. A request to access data is obtained, and based on that request, the method determines that data for the request is stored in two or more data sources of the plurality of different data sources, and selects a particular data source of the two or more data sources for retrieving the data for the request from the particular data source.

### Example Embodiments

Normally there is a manual process of mapping fields to another field across data sources. Duplication of data or overlapping data can present problems. Techniques are presented herein to automate this process. More specifically, a method is provided that utilizes a system of unsupervised models to detect correlation of data attributes in a data lake scenario. The method automatically defines relationships between disparate data sources, and then logs the location of connected data with the intent on providing a “shortest-path-to-data” for downstream consumers of that data.

Moreover, migrations, upgrades, vendor changes, and disparate groups all working in silos tend to generate their own sources of truth or naming conventions based on their particular use case. The techniques presented herein look to identify areas of duplication in metadata and then later capitalize on exposing a catalog of known information for a recognized entity when the data from multiple sources can be correlated.

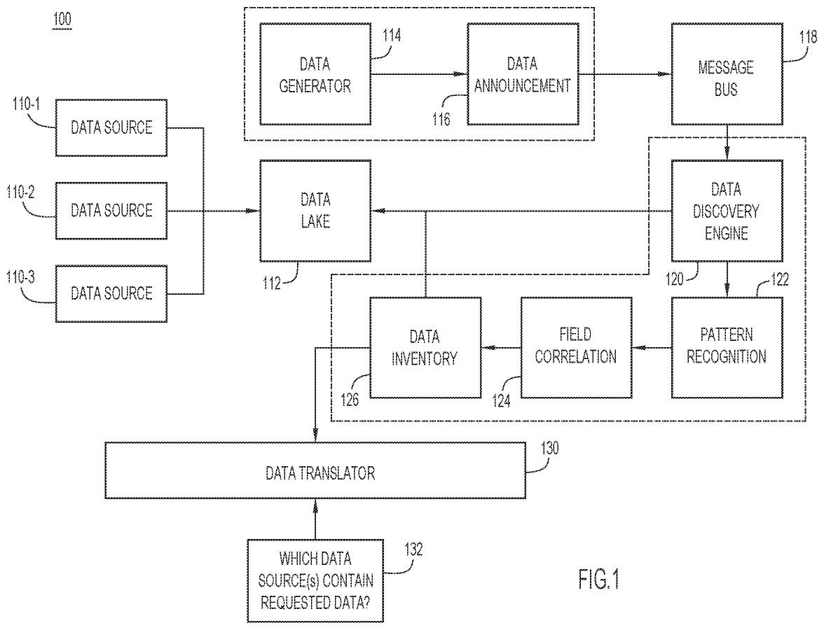

Reference is now made to FIG. 1. FIG. 1 shows a diagram of a system 100 that employs data discovery and relationship mapping to expedite and enhance data retrieval. The system 100 includes a plurality of different data sources, such as three different data sources 110-1. 110-2, and 110-3. These data sources may be integrated into a data lake 112. A data generator 114 is coupled to the data lake 112. The data generator 114 puts data into the data lake 112, and this could be happening from a bus where an entity is announcing that there is new data. The data generator 114 generates a data announcement 116 that indicates the availability of data to a message bus 118. A data discovery engine 120 is coupled to the message bus 118. The data discovery engine 120 performs pattern recognition in the data, field correlation and makes an inventory of the location of the data, e.g., data source 110-1, data source 110-2 or data source 110-3, for example. The data discovery engine 120 performs correlation between data sets when a new dataset is identified or when querying directly into the data lake to mine existing data or to do some correlation between data sets. As part of the discovery process, the data discovery engine 120 may perform pattern recognition 122 and field correlation 124, as well as data inventory 126 to indicate the location of the data. A data translator 130 is provided that receives as input a query 132 to locate a data source for a particular data request, and in particular, to provide a “shortest path” to the data source for the particular data request i.e., “which data source(s) contains the requested data”?

Techniques are provided to determine a pathway of traversing a machine learning (ML)-based pattern recognition engine for the direct delivery of data to a centralized data lake. The separation between the actual data (such as in the data sources 110-1, 110-2 and 110-3) and metadata generated by the data discovery engine 120 allows for a dedicated data inventory component (data inventory 126) that maps metadata of data lake assets for the use by the data translator 130. This separation and alternate paths provides flexibility for the scraping and categorization of existing data lake assets as well as for new assets entering the pipeline.

The various components of FIG. 1, including data lake 112, data generator 114, data discovery engine 120 and data translator 130, may be implemented by computer software instructions that are executed by one or more processors (computer processors) running one or more computing devices, e.g., server computers. The data sources 110-1, 110-2 and 110-3 may be different types of data storage facilities, such as direct-attached storage (DAS), network-attached storage (NAS), storage area network (SAN), and may also involve hard-disk drive storage systems, solid state disk systems, hybrid storage, etc., or any storage technology now known or hereinafter developed.

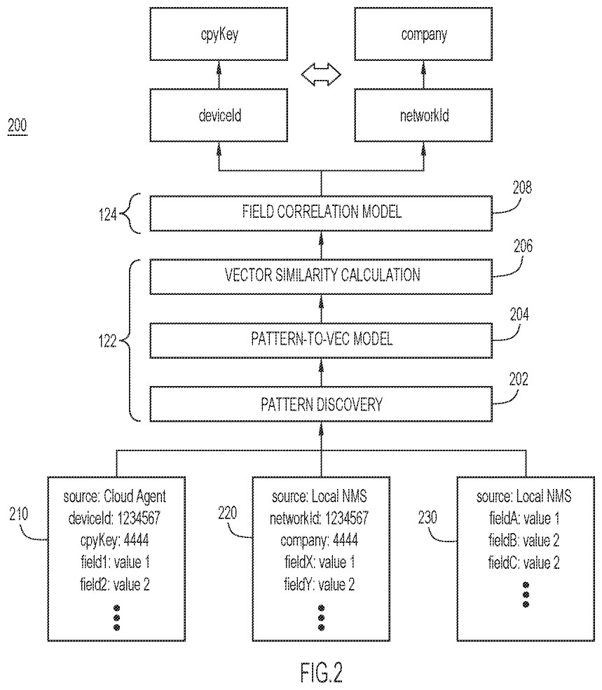

Turning now to FIG. 2, further explanation is provided of the pattern-to-vector (vec) modeling and relationship mapping operations 200 of the data discovery engine 120, and how the correlation of attributes of one data source are compared and identified as being similar to one another. Continued reference to FIG. 1 is also made for the description of FIG. 2. The pattern recognition 122 of the data discovery engine 120 includes a pattern discovery function 202, a pattern-to-vec model 204 and a vector similarity calculation 206. The field correlation 124 of the data discovery engine 120 includes a field correlation model 208.

In this example, structured key/value data has been sent to the data lake. For a simplified version of data, if there are disparate field names associated between two data sources, data source 1 and data source 2, the challenge becomes how to correlate between the two field names. For example, one entity, such as a cloud agent, sends data set 210 to the data lake for a device, where in data set 210, company key (“cpyKey”) and a device identifier (“deviceld”) are used to define a unique identifier for the device. Another entity, such as a network manager service (“Local NMS”), also sends data sets 220 to the data lake for network equipment, where in data set 220, the unique identifier is defined by the “company” and network identifier (“networkid”) fields. Similarly, the network manager service may send data sets of other types, such as shown for data set 230.

The pattern discovery function 202 creates a function that reverse engineers the data for each key and creates a regular expression pattern that defines the value of data. The pattern-to-vec model 204 looks for the distribution of certain patterns that exist for values in data sets. The vector similarity calculation 206 produces one or more similarity metrics that represent similarities of values across data sets. In the example shown in FIG. 2, the output is an indication that “cpyKey” is the same as “company” and “deviceID” is the same as “networkid”.

The pattern discovery function 202 creates regular expression patterns representing/defining values of data. The pattern-to-vec model 204 aggregates the individual patterns into a vector that describes the total patterns that were seen for a given key in a given data source. The vector similarity calculation 206 is generated to identify similarities between data field attributes in different data sources. The field correlation model 208 analyzes the vector similarity calculations do determine if the combination of fields occur together and have similar patterns of values, and generates a confidence score that can be used to identify potential correlation. Patterns of values for a given field are used to define the relationship of data to one or more data sources. While many classification systems exist of a supervised nature, the techniques presented herein identify underlying themes in the relationships of data that can be then used to auto-classify and relate disparate data to other data sources.

The pattern-to-vec model 204 evaluates the values of a given data source field as strings, and determines a regular expression pattern that defines each string. This enables a comparison to be made between the distribution of structures of one or more columns of data from multiple sources without being overly sensitive to the actual content. For the vectorization component, each pattern is represented as a vector (an array of numbers) for the purpose of similarity calculations. As an example, cosine similarity can be used to measure the similarity and distance between two or more vectors, where the resulting value indicates the likelihood that the vectors (and ultimately pattern) are similar to each other. With this similarity metric, the process iterates through each vector in a data set and computes a confidence score of the values in one data source being similar to data in another source by the summation of the similarity metrics between the data sources.

When this process is iterated over multiple fields or columns across multiple data sources, a graph may be created that weights the linkage of each field as it relates to other fields based on the distribution of vector similarity. Confidence of fields associated together can be assessed by evaluating sub-graphs that have high similarity to each other, and this is further compounded when multiple fields from disparate data sets are seen to have similar vector distributions, driving up the confidence that the data between the data sets are indeed similar. For example, fields A and B in data set X are very similar or identical to fields C and D in data set Y. There is a relationship existing between fields in a given set (A->B in data set X, C->D in data set Y), and a confidence that the data is identical in another data set is driven up when there are multiple high similarity matches between fields when comparing data set X to data set Y. This is an unsupervised process in that the model does not require human intervention or training data to assert similarity between fields and the confidence is derived from the combination of multiple fields in a data set having relevance to multiple fields in another. This confidence is then placed in the data catalog for subsequent requests against the data in the shortest path calculation, etc.

This approach is different from a supervised process in that the learning of the relationships between fields of data is based on their similarity of data structure as opposed to a labeling exercise where a human would manually label that a data set has direct correlation to another data set.

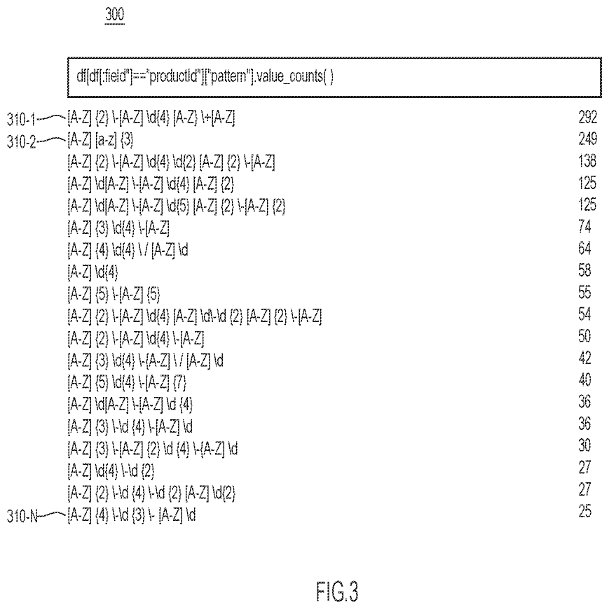

While continuing to refer to FIG. 2, reference is now made to FIG. 3, which illustrates a pattern distribution 300 of a “productId” field in a test data set, for an explanation of how patterns are recognized from data sets. The pattern distribution 300 includes a plurality of different patterns 310-1, 310-2, . . . , 310-N, and an associated count indicating the number of occurrences of the corresponding pattern in a test data set. For example, pattern 310-2 “[A-Z] [a-z] {3}” means an upper case letter followed by 3 lower case letters is a pattern of values that exists for a productId, and that pattern occurred 249 times in the test data set.

As another example, a good indication would be if the “company key” (cpy Key) always uses a 6 digit string and “company” always uses a 6 digit string, then a relationship can be built between them since the patterns are highly correlated.

The pattern-to-vec model 204 could be used across multiple pieces of metadata or fields to further raise confidence that an data entity is the same across separate data sets. As another example, fields named “SSN” vs “Soc. #”, and “Last Name” vs. “Surname” can be used in context together to raise the confidence that they are referring to the same entity (pending the values are the same) by recognizing that the patterns for “SSN” and “Last Name” in one data source are the same as “Soc.” and “Surname” in a different data source. Finding multiple patterns of similarity across differing data sets helps strengthen association. This association, when used to identify that the same entity is referenced across multiple data sources, allows for the ability to correlate data sources from either source to the entity, or prefer retrieval from one source versus another source based on metrics, such as response or workload.

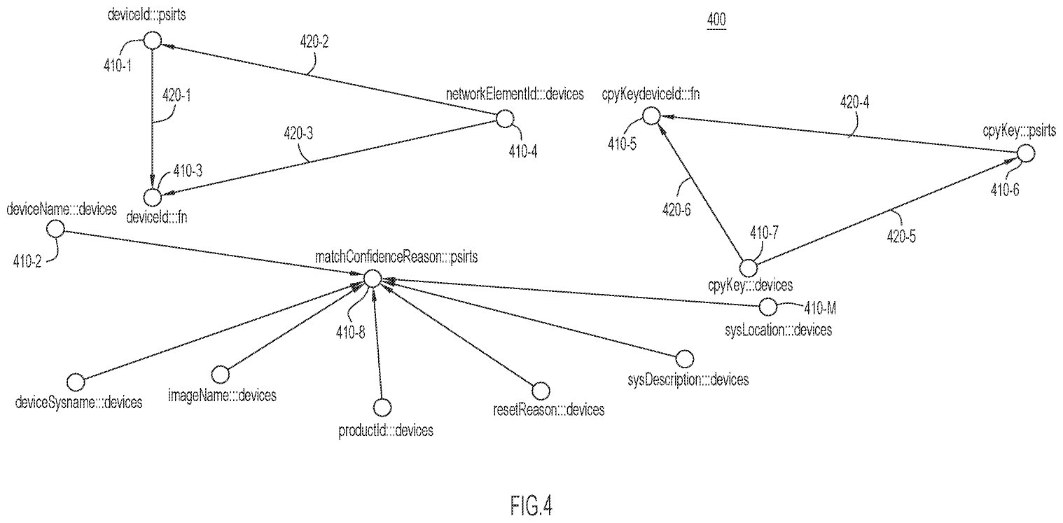

Referring now to FIG. 4, a graph 400 is shown that represents a potential correlation confidence between data sources and fields. FIG. 4 depicts the mapping of fields in a data source (“field name:::source name”) in unique data sets. The pattern-to-vec model 204 (FIG. 2) mines the different patterns to develop a confidence between the different fields across the different data sets based on similarity. If there is a high degree of pattern likelihood at the individual field level or multiple fields then it can be concluded that the fields are the same from a similarity standpoint.

The graph 400 represents the potential correlation confidence between fields as the similarity of their patterns of data becomes closer to equal. Each node 410-1, 410-2, 410-3, 410-4, 410-5, 410-6, 410-7, 410-8 to 410-M in the graph is a field in a given data source. The links between nodes indicates the strength of the potential correlation confidence. For visualization purposes, the links may have different colors, boldness, or other characteristics may be used to indicate the strength of correlation confidence. In the graph 400, links 420-1, 420-2, 420-3, 420-4, 420-5 and 420-6 may have a particular color (e.g., yellow) to indicate that the similarity of patterns of data seen for the given attribute is extremely high and could be considered equal. For example, “deviceld:::psirts” is strongly correlated to “deviceID::::fn” as indicated by link 420-1.

### Shortest-Path-to-Data

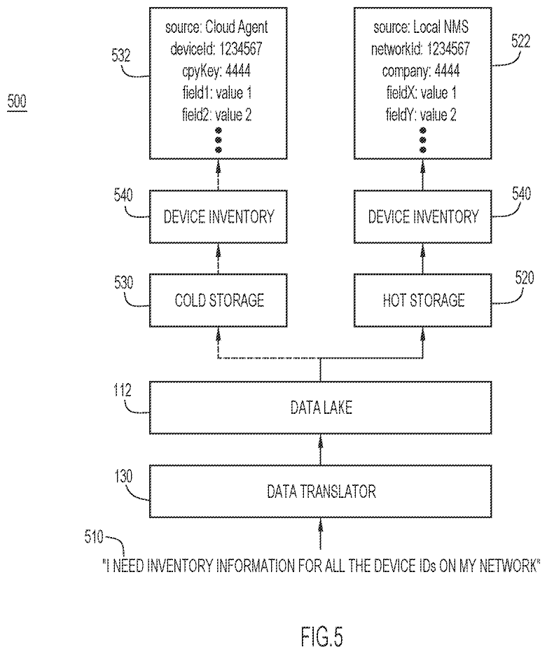

The techniques presented herein rely on the relationship between data that may or may not be present to the querying user, as well as the attributes of how data is stored and access response for that data. Our method includes a translation or data broker overlay that is cognizant of the relationships that have been discovered across the data sources, but also where to retrieve data based on the understanding of data availability and storage location. For example, duplicate data or complimentary data can be returned back to the original query systems based upon response time of one data source versus another. Reference is now made to FIG. 5, which depicts a process 500 by which path selection is made for data retrieval based on data cataloging. The data translator 130 and data lake 112 are shown in FIG. 5 as participating in the process 500.

A request 510 is received at the data translator 130 for device inventory information regardless of the attributes associated with the actual data. The data translator 130, having been made previously aware of correlation between keys across multiple data sources, can evaluate the availability of the requested data based on the efficiency to deliver. In this example, inventory information exists in a “hot” storage location 520 (for the Local NMS data source 522) and in a “cold” storage location 530 (for the Cloud Agent data source 532) that contains the data requested by the querier, based on the field mapping and correlation to data sources. The data translator 130 returns the device inventory data 540 based on the network Id, which correlates to the deviceId contained in the request 510 since the hot storage retrieval is more efficient over the cold storage retrieval. Process 500 provides the shortest path to data by the automatic recognition of relationships in data.

For example, “cold storage” may be older hard drives whereas “hot storage” may be more modern solid state memory storage. Data source 522 has better metrics or less of a cost compared to data source 532, so the request 510 is routed to data source 522. Thus, the shortest path to data can be useful if the requested data stored on older hardware (not in a data lake) or the data lake is just acting as a pointer to where you would find that data, then the system can take into account metrics to facilitate from which data source the data would be retrieved.

The operations depicted in FIGS. 2-4 is to determine similarities in structures of data to ultimately determine that there are potentially multiple sources of data for a given query, and thus, the query is routed to the “shortest path” to the source of data for that query, as depicted in FIG. 5. Field correlation/pattern matching provides information indicating that there is an inventory of applicable data sources, and how similar they are to other data sources, and the fields that map to data in each of those data sources. The data translator 130 takes in metrics of reachability to those different data sources, and may also support a natural language query (“give me my inventory information”) and then uses the metrics in order to determine from which data source to pull the requested data. The natural language query may be a text-based query or an audio-based query that is converted to text for parsing by a natural language processing function running as part of the data translator 130, or as a separate function.

To summarize, presented herein are techniques that employ a pattern-to-vector model that identifies similarity of key-value structured data for the purpose of correlating field names across disconnected data sources. The techniques may involve cataloging of correlated data discovered through unsupervised methods for assisting downstream query channels. Data source capabilities and underlying relationships between data may be used to efficiently select the most appropriate data sources for information delivery. Furthermore, a “shortest-path-to-data” method is provided that translates incoming natural language queries into optimized retrieval of data.

In a dynamic environment where applications or busses are announcing data to a data lake or storage layer, there may not be available a map of fields from one data source to another data source. The presented method of identifying similarity in data field structure is useful for applications in which new data sources are dynamically pulled into a storage layer as it allows for “auto-cataloging” potential overlaps or correlations in data. The presented method can reduce and/or eliminate human intervention.

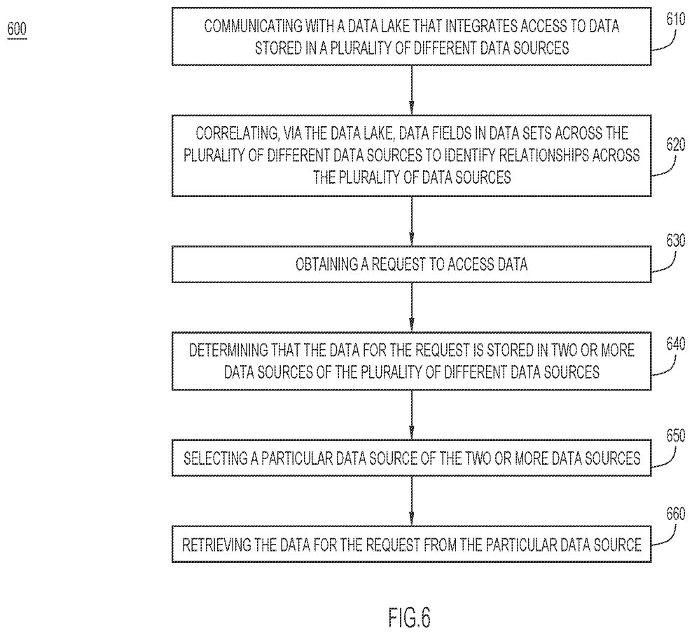

Reference is now made to FIG. 6. FIG. 6 is a flowchart of an example method 600 for accessing data via a data lake that integrates a plurality of different data sources. At step 610, the method 600 includes communicating with a data lake that integrates access to data stored in a plurality of different data sources. For example, as shown in FIG. 1, the data discovery engine 120 communicates with the data lake 112, which in turn integrates access to data stored in a plurality of different data sources, e.g., data sources 110-1, 110-2 and 110-3.

At step 620, the method 600 includes correlating, via the data lake, data fields in data sets across the plurality of different data sources to identify relationships across the plurality of data sources.

At step 630, the method 600 includes obtaining a request to access data.

At step 640, the method 600 includes determining that the data for the request is stored in two or more data sources of the plurality of different data sources.

At step 650, the method 600 includes selecting a particular data source of the two or more data sources. Selecting the particular data source may be based on cost of retrieval and/or capabilities of the two or more data sources, such as retrieving from “hot storage” as opposed to “cold storage”.

At step 660, the method 600 includes retrieving the data for the request from the particular data source.

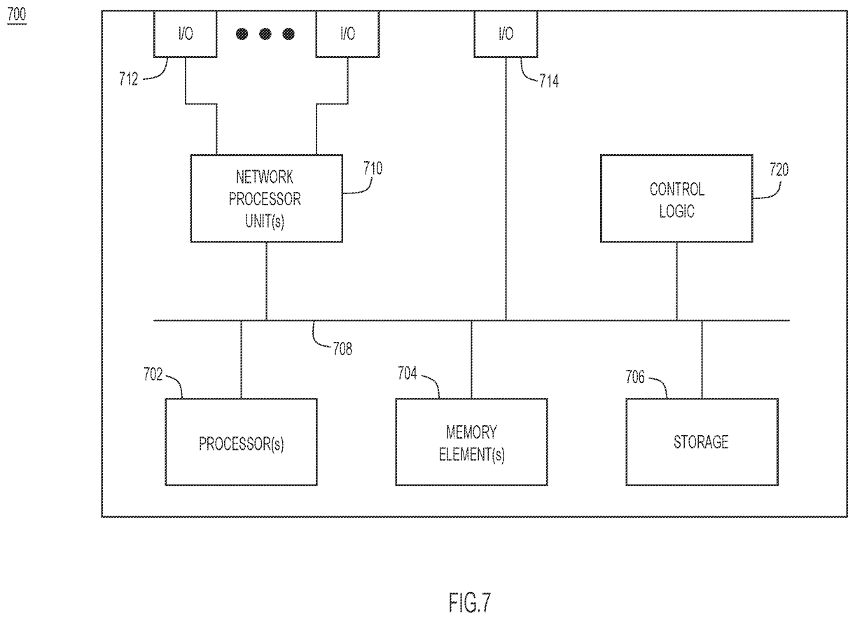

FIG. 7 above illustrates a hardware block diagram of a device 700 (e.g., a network device or computing device) that may perform functions associated with operations discussed herein in connection with the techniques depicted in FIGS. 1-6.

In at least one embodiment, the device 700 may be any apparatus that may include one or more processor(s) 702, one or more memory element(s) 704, storage 706, a bus 708, one or more network processor unit(s) 710 interconnected with one or more network input/output (I/O) interface(s) 712, one or more I/O interface(s) 714, and control logic 720. In various embodiments, instructions associated with logic for device 700 can overlap in any manner and are not limited to the specific allocation of instructions and/or operations described herein.

In at least one embodiment, processor(s) 702 is/are at least one hardware processor configured to execute various tasks, operations and/or functions for device 700 as described herein according to software and/or instructions configured for device 700. Processor(s) 702 (e.g., a hardware processor) can execute any type of instructions associated with data to achieve the operations detailed herein. In one example, processor(s) 702 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 704 and/or storage 706 is/are configured to store data, information, software, and/or instructions associated with device 700, and/or logic configured for memory element(s) 704 and/or storage 706. For example, any logic described herein (e.g., control logic 720) can, in various embodiments, be stored for device 700 using any combination of memory element(s) 704 and/or storage 706. Note that in some embodiments, storage 706 can be consolidated with memory element(s) 704 (or vice versa), or can overlap/exist in any other suitable manner.

In at least one embodiment, bus 708 can be configured as an interface that enables one or more elements of device 700 to communicate in order to exchange information and/or data. Bus 708 can be implemented with any architecture designed for passing control, data and/or information between processors, memory elements/storage, peripheral devices, and/or any other hardware and/or software components that may be configured for device 700. In at least one embodiment, bus 708 may be implemented as a fast kernel-hosted interconnect, potentially using shared memory between processes (e.g., logic), which can enable efficient communication paths between the processes.

In various embodiments, network processor unit(s) 710 may enable communication between device 700 and other systems, entities, etc., via network I/O interface(s) 712 (wired and/or wireless) to facilitate operations discussed for various embodiments described herein. In various embodiments, network processor unit(s) 710 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between device 700 and other systems, entities, etc. to facilitate operations for various embodiments described herein. In various embodiments, network I/O interface(s) 712 can be configured as one or more Ethernet port(s), Fibre Channel ports, any other I/O port(s), and/or antenna(s)/antenna array(s) now known or hereafter developed. Thus, the network processor unit(s) 710 and/or network I/O interface(s) 712 may include suitable interfaces for receiving, transmitting, and/or otherwise communicating data and/or information in a network environment.

I/O interface(s) 714 allow for input and output of data and/or information with other entities that may be connected to device 700. For example, I/O interface(s) 714 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 720 can include instructions that, when executed, cause processor(s) 702 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 720) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 704 and/or storage 706 can store data, software, code, instructions (e.g., processor instructions), logic, parameters, combinations thereof, and/or the like used for operations described herein. This includes memory element(s) 704 and/or storage 706 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In summary, techniques and arrangements are provided herein that enable real-time dynamic reconciliation of the API call flow traffic with custom HTTPS header attributes with or without the header attributes getting dropped at API gateway layer. A trace agent is instantiated as/when needed so as to reasonably construct the mapping table entries even when trace data (in custom HTTP header) could be dropped. The mapping table entries are exported to allow a collector device or process reconcile and create the specific API call flow graph with observability data. This solution can be used in full stack observability to allow for observability detection. A network controller could provision an enterprise applet agent dynamically based on enterprise level rules, or a service provider hosted dynamic applet agent, to provide a dynamic restriction policy at the same time provide end-to-end Internet of Things (IoT) observability is achieved.

In some aspects, the techniques described herein relate to a computer-implemented method including: communicating with a data lake that integrates access to data stored in a plurality of different data sources; correlating, via the data lake, data fields in data sets across the plurality of different data sources to identify relationships across the plurality of different data sources; obtaining a request to access data; determining that the data for the request is stored in two or more data sources of the plurality of different data sources; selecting a particular data source of the two or more data sources; and retrieving the data for the request from the particular data source.

In some aspects, the techniques described herein relate to a method, wherein selecting includes selecting the particular data source based on cost of retrieval and/or capabilities of the two or more data sources.

In some aspects, the techniques described herein relate to a method, wherein correlating includes determining similarity of key-value structured data to correlate field names in data sets across the plurality of different data sources.

In some aspects, the techniques described herein relate to a method, wherein correlating includes: discovering patterns representing field names in data sets across the plurality of different data sources; aggregating the patterns into a vector that describes all patterns observed for a given key in a given data source across the plurality of different data sources; computing a vector similarity that represents similarities among data field attributes across the plurality of different data sources; and analyzing the vector similarity for data field attributes between data sources of the plurality of different data sources to generate a confidence score.

In some aspects, the techniques described herein relate to a method, wherein determining that the data for the request is stored in two or more data sources of the plurality of different data sources is based on the confidence score for similarity of data field attributes between data sources of the plurality of different data sources.

In some aspects, the techniques described herein relate to a method, wherein discovering patterns includes discovering patterns in regular expressions.

In some aspects, the techniques described herein relate to a method, further including, based on the correlating, storing location information identifying two or more data sources of the plurality of different data sources that store similar data, wherein selecting is performed based on the location information.

In some aspects, the techniques described herein relate to a method, wherein obtaining the request includes using natural language processing to derive the request from a text-based or audio-based query.

In some aspects, the techniques described herein relate to a method, wherein correlating is performed using unsupervised machine learning techniques.

In some aspects, the techniques described herein relate to an apparatus including: a communication interface that enables communication with a data lake that integrates access to data stored in a plurality of different data sources; at least one processor device coupled to the communication interface, the at least one processor device configured to perform operations including: correlating data fields in data sets across the plurality of different data sources to identify relationships across the plurality of different data sources; obtaining a request to access data; determining that the data for the request is stored in two or more data sources of the plurality of different data sources; selecting a particular data source of the two or more data sources; and retrieving the data for the request from the particular data source.

In some aspects, the techniques described herein relate to an apparatus, wherein the at least one processor device selects the particular data source based on cost of retrieval and/or capabilities of the two or more data sources.

In some aspects, the techniques described herein relate to an apparatus, wherein the at least one processor device performs the correlating by determining similarity of key-value structured data to correlate field names in data sets across the plurality of different data sources.

In some aspects, the techniques described herein relate to an apparatus, wherein the at least one processor device performs the correlating by: discovering patterns representing field names in data sets across the plurality of different data sources; aggregating the patterns into a vector that describes all patterns observed for a given key in a given data source across the plurality of different data sources; computing a vector similarity that represents similarities among data field attributes across the plurality of different data sources; and analyzing the vector similarity for data field attributes between data sources of the plurality of different data sources to generate a confidence score.

In some aspects, the techniques described herein relate to an apparatus, wherein the at least one processor device determines that the data for the request is stored in two or more data sources of the plurality of different data sources is based on the confidence score for similarity of data field attributes between data sources of the plurality of different data sources.

In some aspects, the techniques described herein relate to an apparatus, wherein the at least one processor device, based on the correlating, stores location information identifying two or more data sources of the plurality of different data sources that store similar data, wherein selecting is performed based on the location information.

In some aspects, the techniques described herein relate to one or more non-transitory computer readable storage media encoded with instructions that, when executed by a processor, cause the processor to perform operations including: communicating with a data lake that integrates access to data stored in a plurality of different data sources; correlating, via the data lake, data fields in data sets across the plurality of different data sources to identify relationships across the plurality of different data sources; obtaining a request to access data; determining that the data for the request is stored in two or more data sources of the plurality of different data sources; selecting a particular data source of the two or more data sources; and retrieving the data for the request from the particular data source.

In some aspects, the techniques described herein relate to a non-transitory computer readable storage media, wherein selecting includes selecting the particular data source based on cost of retrieval and/or capabilities of the two or more data sources.

In some aspects, the techniques described herein relate to a non-transitory computer readable storage media, wherein correlating includes determining similarity of key-value structured data to correlate field names in data sets across the plurality of different data sources.

In some aspects, the techniques described herein relate to a non-transitory computer readable storage media, wherein correlating includes: discovering patterns representing field names in data sets across the plurality of different data sources; aggregating the patterns into a vector that describes all patterns observed for a given key in a given data source across the plurality of different data sources; computing a vector similarity that represents similarities among data field attributes across the plurality of different data sources; and analyzing the vector similarity for data field attributes between data sources of the plurality of different data sources to generate a confidence score.

In some aspects, the techniques described herein relate to a non-transitory computer readable storage media, wherein determining that the data for the request is stored in two or more data sources of the plurality of different data sources is based on the confidence score for similarity of data field attributes between data sources of the plurality of different data sources.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™ mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of and ‘one or more of’ can be represented using the’ (s)′ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

1. A computer-implemented method comprising:
communicating with a data lake that integrates access to data stored in a plurality of different data sources;
correlating, via the data lake, data fields in data sets across the plurality of different data sources to identify relationships across the plurality of different data sources, wherein the relationships are represented by a graph with field names as nodes and correlation confidences as links between the nodes;
obtaining a request to access data;
determining that the data for the request is stored in two or more data sources of the plurality of different data sources;
selecting a particular data source of the two or more data sources based on the correlation confidences and an efficiency metric associated with a respective type of hardware storage provided by each of the two or more data sources; and
retrieving the data for the request from the particular data source.

2. The method of claim 1, wherein selecting comprises selecting the particular data source based on cost of retrieval and/or capabilities of the two or more data sources.

3. The method of claim 1, wherein correlating comprises determining similarity of key-value structured data to correlate the field names in the data sets across the plurality of different data sources.

4. The method of claim 3, wherein correlating includes:
discovering patterns representing the field names in the data sets across the plurality of different data sources;
aggregating the patterns into a vector that describes all patterns observed for a given key in a given data source across the plurality of different data sources;
computing a vector similarity that represents similarities among data field attributes across the plurality of different data sources; and
analyzing the vector similarity for data field attributes between data sources of the plurality of different data sources to generate a confidence score.

5. The method of claim 4, wherein determining that the data for the request is stored in two or more data sources of the plurality of different data sources is based on the confidence score for similarity of data field attributes between data sources of the plurality of different data sources.

6. The method of claim 4, wherein discovering patterns comprises discovering patterns in regular expressions.

7. The method of claim 1, further comprising, based on the correlating, storing location information identifying two or more data sources of the plurality of different data sources that store similar data, wherein selecting is performed based on the location information.

8. The method of claim 1, wherein obtaining the request comprises using natural language processing to derive the request from a text-based or audio-based query.

9. The method of claim 1, wherein correlating is performed using unsupervised machine learning techniques.

10. An apparatus comprising:
a communication interface that enables communication with a data lake that integrates access to data stored in a plurality of different data sources;
at least one processor device coupled to the communication interface, the at least one processor device configured to perform operations including:
correlating data fields in data sets across the plurality of different data sources to identify relationships across the plurality of different data sources, wherein the relationships are represented by a graph with field names as nodes and correlation confidences as links between the nodes;
obtaining a request to access data;
determining that the data for the request is stored in two or more data sources of the plurality of different data sources;
selecting a particular data source of the two or more data sources based on the correlation confidences and an efficiency metric associated with a respective type of hardware storage provided by each of the two or more data sources; and
retrieving the data for the request from the particular data source.

11. The apparatus of claim 10, wherein the at least one processor device selects the particular data source based on cost of retrieval and/or capabilities of the two or more data sources.

12. The apparatus of claim 10, wherein the at least one processor device performs the correlating by determining similarity of key-value structured data to correlate the field names in the data sets across the plurality of different data sources.

13. The apparatus of claim 12, wherein the at least one processor device performs the correlating by:
discovering patterns representing the field names in the data sets across the plurality of different data sources;
aggregating the patterns into a vector that describes all patterns observed for a given key in a given data source across the plurality of different data sources;
computing a vector similarity that represents similarities among data field attributes across the plurality of different data sources; and
analyzing the vector similarity for data field attributes between data sources of the plurality of different data sources to generate a confidence score.

14. The apparatus of claim 13, wherein the at least one processor device determines that the data for the request is stored in two or more data sources of the plurality of different data sources is based on the confidence score for similarity of data field attributes between data sources of the plurality of different data sources.

15. The apparatus of claim 10, wherein the at least one processor device, based on the correlating, stores location information identifying two or more data sources of the plurality of different data sources that store similar data, wherein selecting is performed based on the location information.

16. One or more non-transitory computer readable storage media encoded with instructions that, when executed by a processor, cause the processor to perform operations including:
communicating with a data lake that integrates access to data stored in a plurality of different data sources;
correlating, via the data lake, data fields in data sets across the plurality of different data sources to identify relationships across the plurality of different data sources, wherein the relationships are represented by a graph with field names as nodes and correlation confidences as links between the nodes;
obtaining a request to access data;
determining that the data for the request is stored in two or more data sources of the plurality of different data sources;
selecting a particular data source of the two or more data sources based on the correlation confidences and an efficiency metric associated with a respective type of hardware storage provided by each of the two or more data sources; and
retrieving the data for the request from the particular data source.

17. The non-transitory computer readable storage media of claim 16, wherein selecting comprises selecting the particular data source based on cost of retrieval and/or capabilities of the two or more data sources.

18. The non-transitory computer readable storage media of claim 16, wherein correlating comprises determining similarity of key-value structured data to correlate the field names in the data sets across the plurality of different data sources.

19. The non-transitory computer readable storage media of claim 18, wherein correlating includes:
discovering patterns representing the field names in the data sets across the plurality of different data sources;
aggregating the patterns into a vector that describes all patterns observed for a given key in a given data source across the plurality of different data sources;
computing a vector similarity that represents similarities among data field attributes across the plurality of different data sources; and
analyzing the vector similarity for data field attributes between data sources of the plurality of different data sources to generate a confidence score.

20. The non-transitory computer readable storage media of claim 19, wherein determining that the data for the request is stored in two or more data sources of the plurality of different data sources is based on the confidence score for similarity of data field attributes between data sources of the plurality of different data sources.

21. The method of claim 1, wherein the correlation confidences are determined based on vector distribution similarities of data patterns associated with the data fields.

22. The method of claim 1, wherein the efficiency metric is determined based on an age of the respective type of hardware storage, and wherein the respective type of hardware storage includes one or more of a hard disk drive storage or a solid state memory storage.
